(19) United States
(12) Patent Application Publication
(10) Pub. No.: US 2019/0394769 A1
(43) Pub. Date: Dec. 26, 2019

(54) TECHNIQUES AND APPARATUSES FOR TRANSMISSION TIME INTERVAL (TTI) BUNDLING WITH VARIABLE BUNDLE SIZE

(71) Applicant: QUALCOMM Incorporated, San Diego, CA (US)

(72) Inventor: Arun Gilda, Hyderabad (IN)

(21) Appl. No.: 16/014,698

(22) Filed: Jun. 21, 2018

(51) Int. Cl. H04W 72/04; H04L 1/18

(52) U.S. Cl. CPC H04W 72/0446; H04L 1/1861

(57) ABSTRACT

Various aspects of the present disclosure generally relate to wireless communication. In some aspects, a user equipment (UE) may receive an indication to enable transmission time interval (TTI) bundling. The UE may determine a number of redundancy versions to be transmitted in a corresponding number of TTIs for the TTI bundling. The UE may transmit the determined number of redundancy versions in the corresponding number of TTIs. Numerous other aspects are provided.

### FIELD OF THE DISCLOSURE

Aspects of the present disclosure generally relate to wireless communication, and more particularly to techniques and apparatuses for transmission time interval (TTI) bundling with variable bundle size.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving an indication to enable transmission time interval (TTI) bundling; determining a number of redundancy versions to be transmitted in a corresponding number of TTIs for the TTI bundling; and transmitting the determined number of redundancy versions in the corresponding number of TTIs.

In some aspects, a UE for wireless communication may include memory and one or more processors operatively coupled to the memory. The memory and the one or more processors may be configured to receive an indication to enable transmission time interval (TTI) bundling; determine a number of redundancy versions to be transmitted in a corresponding number of TTIs for the TTI bundling; and transmit the determined number of redundancy versions in the corresponding number of TTIs.

In some aspects, a non-transitory computer-readable medium may store one or more instructions for wireless communication. The one or more instructions, when executed by one or more processors of a UE, may cause the one or more processors to receive an indication to enable transmission time interval (TTI) bundling; determine a number of redundancy versions to be transmitted in a corresponding number of TTIs for the TTI bundling; and transmit the determined number of redundancy versions in the corresponding number of TTIs.

In some aspects, an apparatus for wireless communication may include means for receiving an indication to enable transmission time interval (TTI) bundling; means for determining a number of redundancy versions to be transmitted in a corresponding number of TTIs for the TTI bundling; and means for transmitting the determined number of redundancy versions in the corresponding number of TTIs.

Aspects generally include a method, apparatus, system, computer program product, non-transitory computer-readable medium, user equipment, base station, wireless communication device, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3 is a block diagram conceptually illustrating an example of a frame structure in a wireless communication network, in accordance with various aspects of the present disclosure.

FIG. 4 is a diagram illustrating an example of TTI bundling with a bundle size of four, in accordance with various aspects of the present disclosure.

FIG. 5 is a diagram illustrating another example of TTI bundling with a bundle size of four, in accordance with various aspects of the present disclosure.

FIG. 6 is a diagram illustrating an example of TTI bundling with variable bundle size, in accordance with various aspects of the present disclosure.

FIG. 7 is a diagram illustrating another example of TTI bundling with variable bundle size, in accordance with various aspects of the present disclosure.

FIG. 8 is a diagram illustrating an example process performed, for example, by a user equipment, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It is noted that while aspects may be described herein using terminology commonly associated with 3G and/or 4G wireless technologies, aspects of the present disclosure can be applied in other generation-based communication systems, such as 5G and later, including NR technologies.

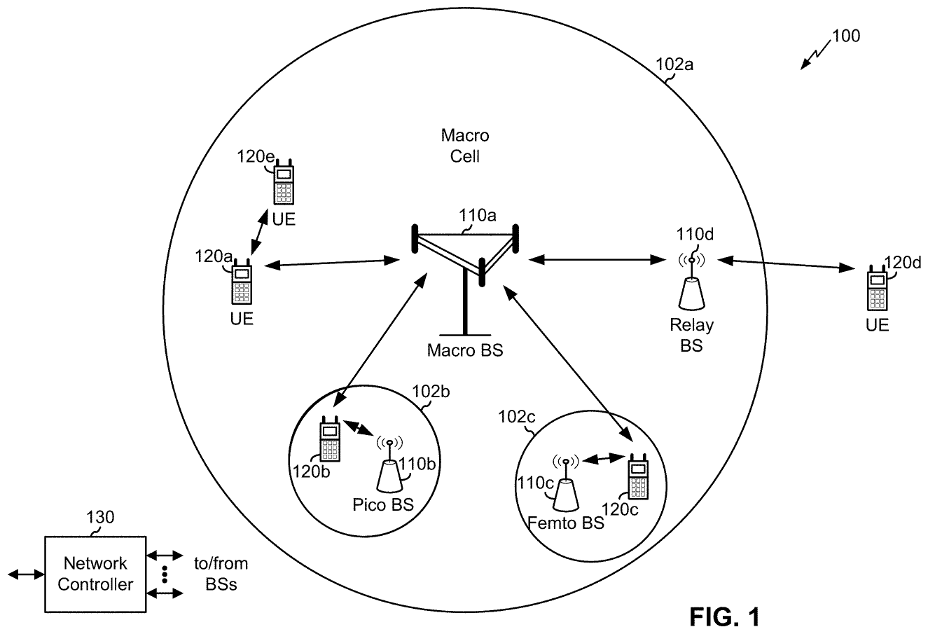

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, such as sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided merely as an example. Other examples are possible and may differ from what was described with regard to FIG. 1.

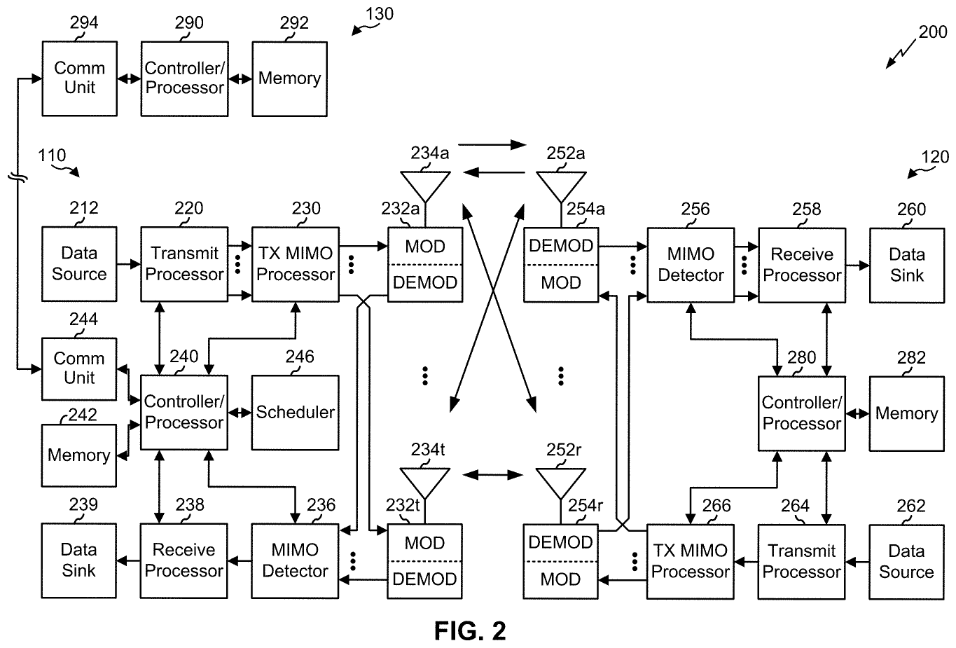

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

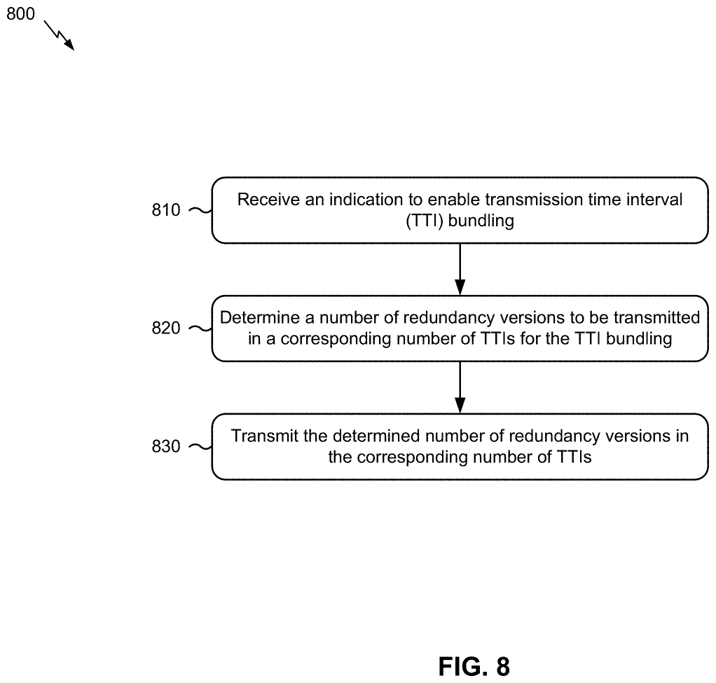

In some aspects, one or more components of UE 120 may be included in a housing. Controller/processor 240 of base station 110, controller/processor 280 of UE 120, and/or any other component(s) of FIG. 2 may perform one or more techniques associated with TTI bundling with variable bundle size, as described in more detail elsewhere herein. For example, controller/processor 240 of base station 110, controller/processor 280 of UE 120, and/or any other component(s) of FIG. 2 may perform or direct operations of, for example, process 800 of FIG. 8 and/or other processes as described herein. Memories 242 and 282 may store data and program codes for base station 110 and UE 120, respectively. A scheduler 246 may schedule UEs for data transmission on the downlink and/or uplink.

In some aspects, UE 120 may include means for receiving an indication to enable transmission time interval (TTI) bundling; means for determining a number of redundancy versions to be transmitted in a corresponding number of TTIs for the TTI bundling; means for transmitting the determined number of redundancy versions in the corresponding number of TTIs; and/or the like. In some aspects, such means may include one or more components of UE 120 described in connection with FIG. 2.

As indicated above, FIG. 2 is provided merely as an example. Other examples are possible and may differ from what was described with regard to FIG. 2.

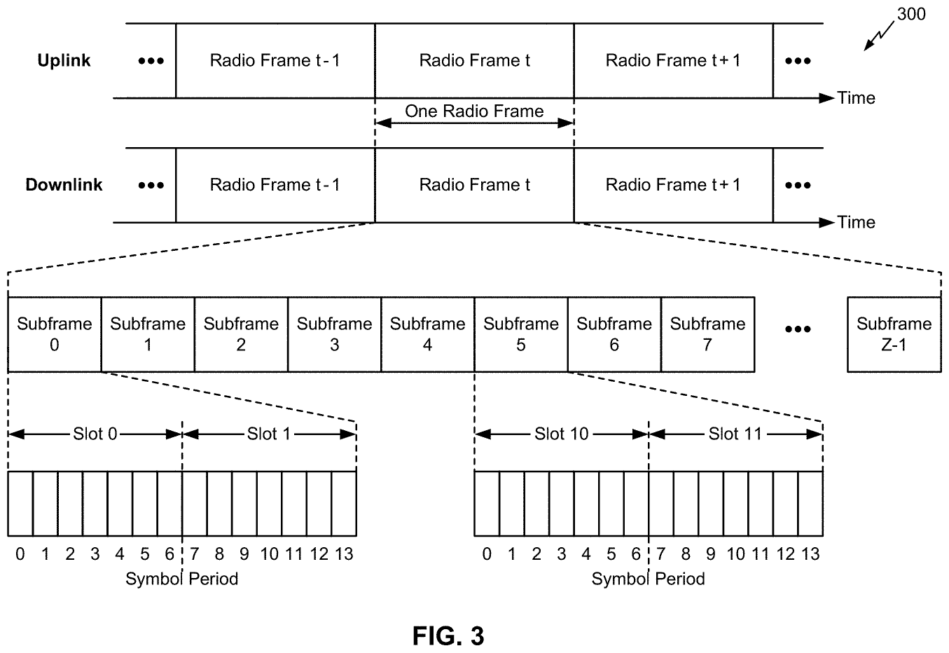

FIG. 3 shows an example frame structure 300 for FDD in a telecommunications system (e.g., NR). The transmission timeline for each of the downlink and uplink may be partitioned into units of radio frames. Each radio frame may have a predetermined duration and may be partitions into a set of Z (Z≥1) subframes (e.g., with indices of 0 through Z−1). Each subframe may include a set of slots (e.g., two slots per subframe are shown in FIG. 3). Each slot may include a set of L symbol periods. For example, each slot may include seven symbol periods (e.g., as shown in FIG. 3), fifteen symbol periods, and/or the like. In a case where the subframe includes two slots, the subframe may include 2L symbol periods, where the 2L symbol periods in each subframe may be assigned indices of 0 through 2L−1. In some aspects, a scheduling unit for the FDD may frame-based, subframe-based, slot-based, symbol-based, and/or the like.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol. Additionally, or alternatively, different configurations of wireless communication structures than those shown in FIG. 3 may be used.

As indicated above, FIG. 3 is provided as an example. Other examples are possible and may differ from what was described with regard to FIG. 3.

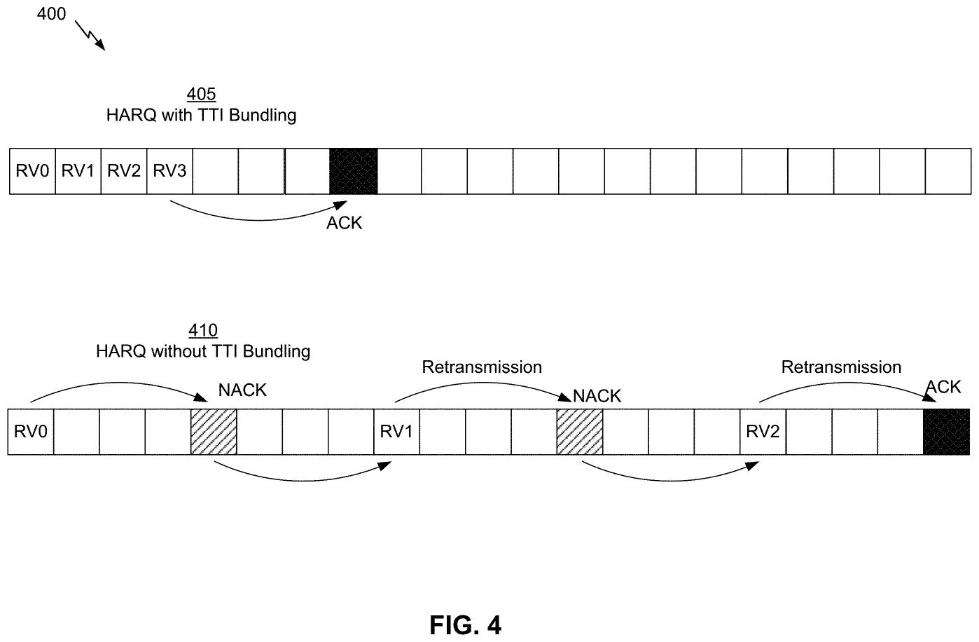

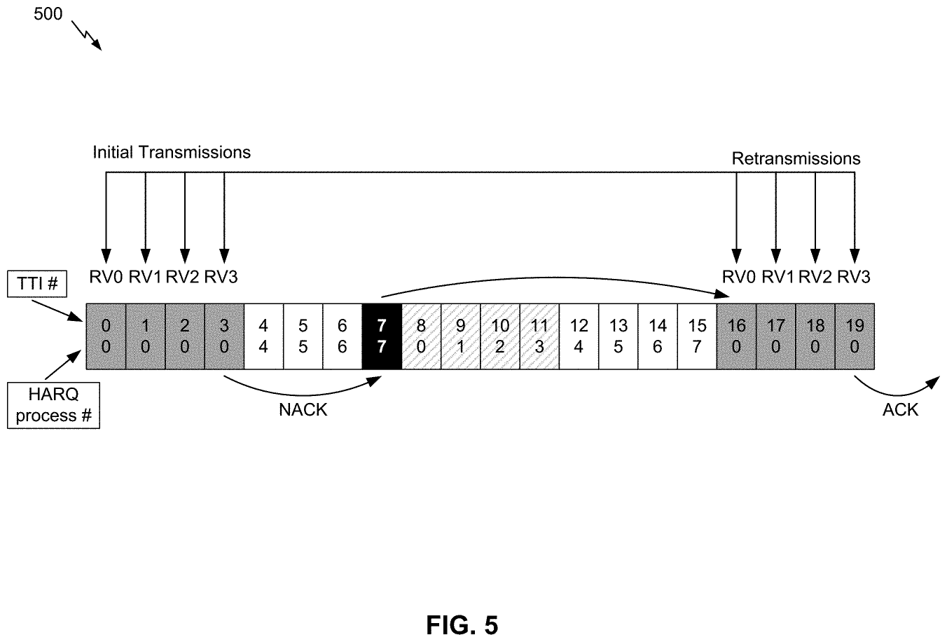

FIGS. 4 and 5 are diagrams illustrating examples 400 and 500 of TTI bundling with a bundle size of four, in accordance with various aspects of the present disclosure.

As shown in FIG. 4, a UE 120 may transmit uplink data to a base station 110 using transmission time interval (TTI) bundling. As shown by reference number 405, with TTI bundling, the UE 120 transmits four hybrid automatic repeat request (HARQ) redundancy versions (RVs) of the uplink data in four corresponding TTIs (e.g., subframes and/or the like) that are consecutive in time. As shown by reference number 410, without TTI bundling, the UE 120 may transmit a first RV, may wait for acknowledgement (ACK) or negative acknowledgement (NACK) (ACK/NACK) feedback, may transmit a second RV if a NACK is received for the first RV, may wait for ACK/NACK feedback for the second RV, and so on until an ACK is received.

Thus, TTI bundling may reduce latency, particularly in scenarios where an ACK is unlikely to be received for the initial transmission (e.g., when the UE 120 is experiencing poor channel conditions, has limited transmit power, and/or the like). For example, in example 400 of FIG. 4, an ACK is received in the seventh subframe after transmission of the initial RV (shown as RV0) when TTI bundling is used, but an ACK is not received until the twentieth subframe after transmission of the initial RV when TTI bundling is not used. When channel conditions are very poor, TTI bundling may reduce latency even further. For example, in example 500 of FIG. 5, transmission of all 4 redundancy versions using TTI bundling may still result in a NACK when channel conditions are very poor. However, retransmission of all 4 RVs using TTI bundling may result in an ACK. Without TTI bundling, each individual RV would be separated by (for example) at least 8 subframes, resulting in much higher latency.

In some aspects, TTI bundling may be enabled for a UE 120 (e.g., by a base station 110) when the UE 120 is experiencing poor channel conditions, such as when the UE 120 is located near a cell edge and/or when the UE 120 has power limitations that prevent the UE 120 from transmitting the uplink data with a high transmit power. This increases the likelihood that the base station 110 successfully receives the uplink data when the UE 120 is in these limiting conditions. According to the 3GPP specification, TTI bundling may be enabled when the UE 120 is in poor channel conditions, and may always bundle 4 RVs of the uplink data in 4 consecutive TTIs, as shown in FIGS. 4 and 5. Thus, TTI bundling may always use a bundle size of 4 RVs. However, bundling a different number of RVs (e.g., other than 4) in a corresponding number of TTIs may be beneficial in a variety of scenarios depending on channel conditions.

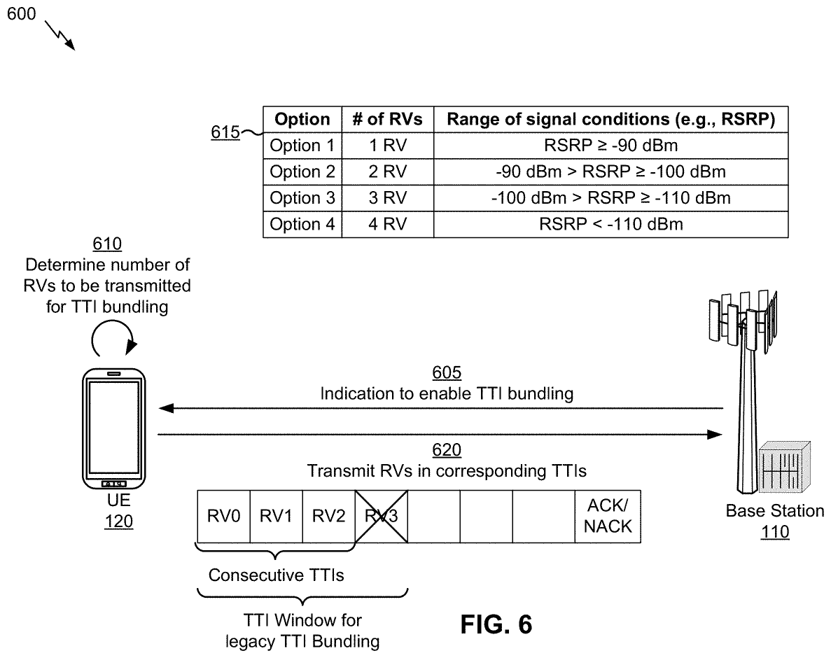

Some techniques and apparatuses described herein (e.g., in connection with FIGS. 6-8, below) permit more granular application of TTI bundling to permit the UE 120 to transmit a different number of RVs of uplink data for TTI bundling (e.g., other than 4 RVs, as shown in FIGS. 4-5). For example, the UE 120 may transmit 2 RVs of uplink data in 2 consecutive TTIs, may transmit 3 RVs of uplink data in 3 consecutive TTIs, and/or the like. In some cases, the UE 120 may determine the number of RVs to be bundled in TTI bundling based at least in part on channel conditions (e.g., a signal strength, a signal quality, and/or the like) and/or ACK/NACK feedback received from a base station 110. Furthermore, the UE 120 may dynamically adjust the number of bundled RVs as channel conditions and/or ACK/NACK feedback changes.

By using a bundle size other than 4 for TTI bundling, UE performance (e.g., call quality, connection quality, and/or the like) may be improved in scenarios where channel conditions are somewhat weak, but not weak enough to trigger TTI bundling with a bundle size of 4 (e.g., according to criteria in the 3GPP specification associated with TTI bundling with a bundle size of 4). Furthermore, network resources (e.g., time and/or frequency resources), UE resources (e.g., memory, processing power, battery power, and/or the like), and base station resources (e.g., memory, processing power, and/or the like) may be conserved when fewer than 4 RVs are used. Additional details are described below.

As indicated above, FIGS. 4 and 5 are provided as examples. Other examples are possible and may differ from what was described with regard to FIGS. 4 and 5.

FIG. 6 is a diagram illustrating an example 600 of TTI bundling with variable bundle size, in accordance with various aspects of the present disclosure.

As shown by reference number 605, a base station 110 may transmit, and a UE 120 may receive, an indication to enable TTI bundling. In some aspects, the indication may be included in a radio resource control (RRC) message, downlink control information (DCI), and/or the like. The TTI bundling may be associated with a default bundle size of 4 redundancy version (RVs), and/or the indication may indicate a bundle size of 4 RVs, as described above in connection with FIGS. 4 and 5.

In some aspects, TTI bundling may be triggered based at least in part on a measurement report that indicates a signal condition (e.g., a reference signal received power (RSRP) value, a reference signal received quality (RSRQ) value, a received signal strength indicator (RSSI) value, a signal to noise ratio (SINR) value, and/or the like that is less than or equal to a threshold), a capability report that indicates a UE capability (e.g., a maximum transmit power that is less than or equal to a threshold), a power headroom report that indicates a transmit power associated with the UE 120 (e.g., a transmit power less than or equal to a threshold), and/or the like.

As shown by reference number 610, the UE 120 may determine a number of RVs to be transmitted (e.g., in a corresponding number of TTIs) for the TTI bundling. In some aspects, the determined number of RVs is less than 4. As described above in connection with FIGS. 4 and 5, by using a bundle size less than 4 for TTI bundling, the UE 120 may improve performance, call quality, and/or the like in scenarios where channel conditions are somewhat weak, but not weak enough to trigger TTI bundling with a bundle size of 4 (e.g., according to criteria in the 3GPP specification associated with TTI bundling with a bundle size of 4). In this case, a different threshold may be used to trigger TTI bundling with a bundle size other than 4 as compared to a threshold used to trigger TTI bundling with a bundle size of 4. Furthermore, by using a bundle size less than 4, network resources, UE resources, and base station resources may be conserved.

As shown by reference number 615, in some aspects, the UE 120 may determine the number of redundancy versions by selecting from a plurality of options. In some aspects, each option may correspond to a different number of RVs (e.g., one RV, two RVs, three RVs, or four RVs). In some aspects, the plurality of options may be hard coded and/or preconfigured in memory of the UE 120. Additionally, or alternatively, the plurality of options may be indicated to the UE 120 by the base station 110, such as in an RRC message, system information, and/or the like.

As shown, in some aspects, each of the plurality of options may correspond to a different signal condition and/or a different range of signal conditions. For example, if the RSRP measured by the UE 120 is greater than or equal to −90 dBm, then the UE 120 may determine to transmit 1 RV. As another example, if the RSRP measured by the UE 120 is less than −90 dBm and greater than or equal to −100 dBm, then the UE 120 may determine to transmit 2 RVs. As another example, if the RSRP measured by the UE 120 is less than −100 dBm and greater than or equal to −110 dBm, then the UE 120 may determine to transmit 3 RVs. As another example, if the RSRP measured by the UE 120 is less than −110 dBm, then the UE 120 may determine to transmit 4 RVs. These ranges are provided as example, and other ranges may be used. Furthermore, a parameter other than RSRP may be used to determine the signal condition, such as SINR, RSRQ, RSSI, and/or the like.

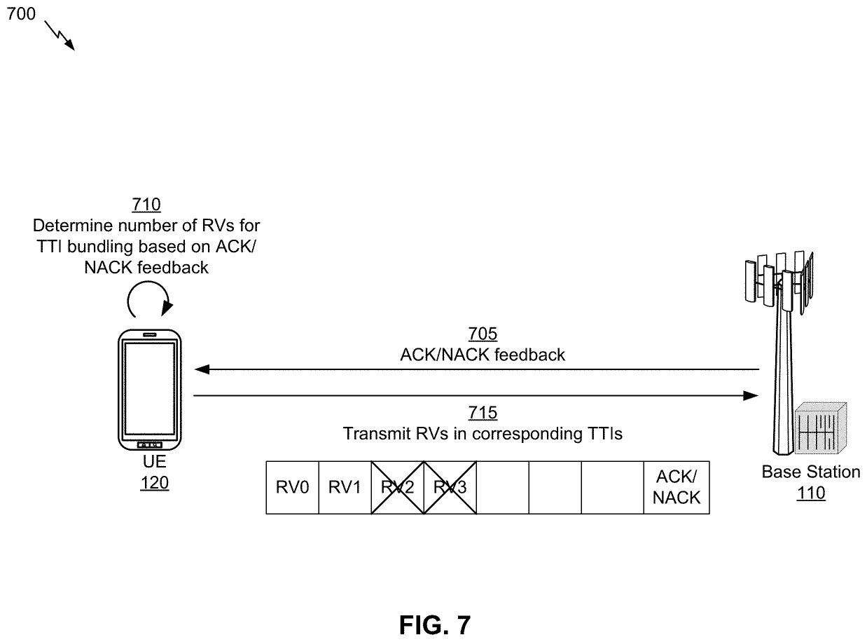

In some aspects, the UE 120 may determine the number of RVs based at least in part on at least one signal condition, as shown in FIG. 6. For example, the UE 120 may measure a signal parameter, such as an RSRP parameter, an RSRQ parameter, an RSSI parameter, a SINR parameter, and/or the like, and may determine whether a measured value of the signal parameter satisfies a condition. The condition may include, for example, the measured value satisfying a threshold, the measured value failing to satisfy a threshold, the measured value satisfying a first threshold but failing to satisfy a second threshold, and/or the like. Additionally, or alternatively, the UE 120 may determine the number of RVs based at least in part on ACK or NACK (ACK/NACK) feedback received from the base station 110, as described in more detail below in connection with FIG. 7.

As shown by reference number 620, the UE 120 may transmit, and the base station 110 may receive, the determined number of redundancy versions. As shown, the determined number of RVs may be transmitted in a corresponding number of TTIs. In example 600, the UE 120 determines to transmit 3 RVs, shown as RV0, RV1, and RV2. As shown, in some aspects, the determined number of RVs may be transmitted in a corresponding number of consecutive TTIs (e.g., 3 consecutive TTIs for 3 RVs).

Additionally, or alternatively, the determined number of RVs may be transmitted in a corresponding number of TTIs that are included in a window of 4 consecutive TTIs used for legacy TTI bundling (e.g., a TTI bundling window). However, in some aspects, fewer than 4 of those TTIs may be used for TTI bundling (e.g., if the UE 120 determines to transmit fewer than 4 RVs). For example, the UE 120 does not transmit a fourth RV (shown as an X through RV3) in example 600. In this way, network resources and UE resources may be conserved. In some aspects, the RVs may be transmitted in consecutive TTIs at the beginning of the TTI bundling window, as shown. Alternatively, the RVs may be transmitted in consecutive TTIs at the end of the TTI bundling window.

In some aspects, the UE 120 may indicate, to the base station 110, whether the UE 120 supports the flexible TTI bundling described herein (e.g., whether the UE 120 supports transmitting fewer than 4 RVs for TTI bundling). Additionally, or alternatively, the base station 110 may indicate, to the UE 120, whether the base station 110 supports flexible TTI bundling. In some aspects, such capabilities may be indicated in an RRC capability exchange. Additionally, or alternatively, the UE 120 may indicate whether the UE 120 has enabled or disabled flexible TTI bundling, and/or the base station 110 may instruct the UE 120 to enable or disable flexible TTI bundling. In some aspects, such indication may be included in an RRC message, DCI, and/or the like.

As indicated above, FIG. 6 is provided as an example. Other examples are possible and may differ from what was described with regard to FIG. 6.

FIG. 7 is a diagram illustrating another example 700 of TTI bundling with variable bundle size, in accordance with various aspects of the present disclosure.

As shown by reference number 705, a base station 110 may transmit, and a UE 120 may receive, ACK/NACK feedback. In some aspects, the ACK/NACK feedback may correspond to an uplink communication transmitted using TTI bundling. Additionally, or alternatively, the ACK/NACK feedback may include multiple ACKs and/or NACKs over a time period.

As shown by reference number 710, the UE 120 may determine a number of RVs to be used for TTI bundling based at least in part on the ACK/NACK feedback. In some aspects, the determined number of RVs may be less than 4, as described above in connection with FIG. 6. In some aspects, the UE 120 may determine the number of redundancy versions by selecting from a plurality of options, as described above in connection with FIG. 6. In some aspects, each of the plurality of options may correspond to a different number of ACKs and/or NACKs received in a time period and/or a different range of numbers of ACKs and/or NACKs received in a time period.

Additionally, or alternatively, the UE 120 may increment or decrement a number of RVs previously used for TTI bundling based at least in part on a number of ACKs and/or NACKs received in a time period. For example, if the UE 120 receives a threshold number of ACKs within a time period, then the UE 120 may decrement a number of RVs to be used for TTI bundling, thereby conserving network resources. Additionally, or alternatively, if the UE 120 receives a threshold number of NACKs within a time period, then the UE 120 may increment a number of RVs to be used for TTI bundling, thereby increasing the likelihood of successful reception of an uplink communication by the base station 110.

As shown by reference number 715, the UE 120 may transmit, and the base station 110 may receive, the determined number of redundancy versions. As shown, the determined number of RVs may be transmitted in a corresponding number of TTIs. In example 700, the UE 120 determines to transmit 2 RVs, shown as RV0 and RV1. For example, if the UE 120 previously transmitted 3 RVs, as described above in connection with FIG. 6, and then receives a threshold number of ACKs within a time period, then the UE 120 may decrement the number of RVs to 2 RVs, as shown in FIG. 7. As shown, in some aspects, the determined number of RVs may be transmitted in a corresponding number of consecutive TTIs (e.g., 2 consecutive TTIs for 2 RVs). Additionally, or alternatively, the determined number of RVs may be transmitted in a corresponding number of TTIs that are included in a window of 4 consecutive TTIs used for legacy TTI bundling, in a similar manner as described above in connection with FIG. 6.

As indicated above, FIG. 7 is provided as an example. Other examples are possible and may differ from what was described with regard to FIG. 7.

FIG. 8 is a diagram illustrating an example process 800 performed, for example, by a UE, in accordance with various aspects of the present disclosure. Example process 800 is an example where a UE (e.g., UE 120 and/or the like) performs TTI bundling with variable bundle size.

As shown in FIG. 8, in some aspects, process 800 may include receiving an indication to enable transmission time interval (TTI) bundling (block 810). For example, the UE (e.g., using antenna 252, DEMOD 254, MIMO detector 256, receive processor 258, controller/processor 280, and/or the like) may receive an indication to enable TTI bundling, as described above in connection with FIGS. 6-7.

As further shown in FIG. 8, in some aspects, process 800 may include determining a number of redundancy versions to be transmitted in a corresponding number of TTIs for the TTI bundling (block 820). For example, the UE (e.g., using controller/processor 280 and/or the like) may determine a number of redundancy versions to be transmitted in a corresponding number of TTIs for the TTI bundling, as described above in connection with FIGS. 6-7.

As further shown in FIG. 8, in some aspects, process 800 may include transmitting the determined number of redundancy versions in the corresponding number of TTIs (block 830). For example, the UE (e.g., using controller/processor 280, transmit processor 264, TX MIMO processor 266, MOD 254, antenna 252, and/or the like) may transmit the determined number of redundancy versions in the corresponding number of TTIs, as described above in connection with FIGS. 6-7.

Process 800 may include additional aspects, such as any single aspect or any combination of aspects described below and/or in connection with one or more other processes described elsewhere herein.

In some aspects, the number of redundancy versions is selected from a plurality of options. In some aspects, the plurality of options includes at least two of: one redundancy version, two redundancy versions, three redundancy versions, or four redundancy versions. In some aspects, each of the plurality of options corresponds to a range of signal conditions. In some aspects, the determined number of redundancy versions is less than four.

In some aspects, the number of redundancy versions is four for a reference signal received power (RSRP) value less than −110 decibels per milliwatt (dBm), is three for an RSRP value between −100 dBm and −110 dBm, is two for an RSRP value between −90 dBm and −100 dBm, or is one for an RSRP value greater than −90 dBm.

In some aspects, the number of redundancy versions is determined based at least in part on one or more of: at least one signal condition, acknowledgement or negative acknowledgement (ACK/NACK) feedback received by the UE, or a combination thereof. In some aspects, the UE may determine, after transmitting the determined number of redundancy versions, a different number of redundancy versions to be transmitted in a corresponding different number of TTIs for the TTI bundling; and may transmit the different number of redundancy versions in the corresponding different number of TTIs. In some aspects, the different number of redundancy versions is determined based at least in part on: decrementing the determined number of redundancy versions based at least in part on a determination that a threshold number of acknowledgments (ACKs) have been received by the UE within a time period, or incrementing the determined number of redundancy versions based at least in part on a determination that a threshold number of negative acknowledgments (NACKs) have been received by the UE within a time period.

In some aspects, the TTIs, of the corresponding number of TTIs, are consecutive. In some aspects, the TTIs, of the corresponding number of TTIs, are included in a window of four consecutive TTIs.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving an indication to enable transmission time interval (TTI) bundling;
determining a number of redundancy versions to be transmitted in a corresponding number of TTIs for the TTI bundling, wherein the number of redundancy versions is four for a reference signal received power (RSRP) value less than −110 decibels per milliwatt (dBm), is three for an RSRP value between −100 dBm and −110 dBm, is two for an RSRP value between −90 dBm and −100 dBm, or is one for an RSRP value greater than −90 dBm; and
transmitting the determined number of redundancy versions in the corresponding number of TTIs.

2. The method of claim 1, wherein the number of redundancy versions is selected from a plurality of options.

3. The method of claim 2, wherein the plurality of options includes at least two of: one redundancy version, two redundancy versions, three redundancy versions, or four redundancy versions.

4. The method of claim 2, wherein each of the plurality of options corresponds to a range of signal conditions.

5. The method of claim 1, wherein the determined number of redundancy versions is less than four.

6. (canceled)

7. The method of claim 1, wherein the number of redundancy versions is determined based at least in part on one or more of:
at least one signal condition,
acknowledgement or negative acknowledgement (ACK/NACK) feedback received by the UE, or
a combination thereof.

8. The method of claim 1, further comprising:
determining, after transmitting the determined number of redundancy versions, a different number of redundancy versions to be transmitted in a corresponding different number of TTIs for the TTI bundling; and
transmitting the different number of redundancy versions in the corresponding different number of TTIs.

9. The method of claim 8, wherein the different number of redundancy versions is determined based at least in part on:
decrementing the determined number of redundancy versions based at least in part on a determination that a threshold number of acknowledgments (ACKs) have been received by the UE within a time period, or
incrementing the determined number of redundancy versions based at least in part on a determination that a threshold number of negative acknowledgments (NACKs) have been received by the UE within a time period.

10. The method of claim 1, wherein the TTIs, of the corresponding number of TTIs, are consecutive.

11. The method of claim 1, wherein the TTIs, of the corresponding number of TTIs, are included in a window of four consecutive TTIs.

12. A user equipment (UE) for wireless communication, comprising:
memory; and
one or more processors operatively coupled to the memory, the memory and the one or more processors configured to:
receive an indication to enable transmission time interval (TTI) bundling;
determine a number of redundancy versions to be transmitted in a corresponding number of TTIs for the TTI bundling, wherein the number of redundancy versions is four for a reference signal received power (RSRP) value less than −110 decibels per milliwatt (dBm), is three for an RSRP value between −100 dBm and −110 dBm, is two for an RSRP value between −90 dBm and −100 dBm, or is one for an RSRP value greater than −90 dBm; and
transmit the determined number of redundancy versions in the corresponding number of TTIs.

13. The UE of claim 12, wherein the number of redundancy versions is selected from a plurality of options.

14. The UE of claim 13, wherein the plurality of options includes at least two of: one redundancy version, two redundancy versions, three redundancy versions, or four redundancy versions.

15. The UE of claim 13, wherein each of the plurality of options corresponds to a range of signal conditions.

16. The UE of claim 12, wherein the determined number of redundancy versions is less than four.

17. (canceled)

18. The UE of claim 12, wherein the number of redundancy versions is determined based at least in part on one or more of:
at least one signal condition,
acknowledgement or negative acknowledgement (ACK/NACK) feedback received by the UE, or
a combination thereof.

19. The UE of claim 12, wherein the one or more processors are further configured to:
determine, after transmitting the determined number of redundancy versions, a different number of redundancy versions to be transmitted in a corresponding different number of TTIs for the TTI bundling; and
transmit the different number of redundancy versions in the corresponding different number of TTIs.

20. The UE of claim 19, wherein the different number of redundancy versions is determined based at least in part on:
decrementing the determined number of redundancy versions based at least in part on a determination that a threshold number of acknowledgments (ACKs) have been received by the UE within a time period, or
incrementing the determined number of redundancy versions based at least in part on a determination that a threshold number of negative acknowledgments (NACKs) have been received by the UE within a time period.

21. The UE of claim 12, wherein the TTIs, of the corresponding number of TTIs, are consecutive.

22. The UE of claim 12, wherein the TTIs, of the corresponding number of TTIs, are included in a window of four consecutive TTIs.

23. A non-transitory computer-readable medium storing one or more instructions for wireless communication, the one or more instructions comprising:
one or more instructions that, when executed by one or more processors of a user equipment (UE), cause the one or more processors to:
receive an indication to enable transmission time interval (TTI) bundling;
determine a number of redundancy versions to be transmitted in a corresponding number of TTIs for the TTI bundling, wherein the number of redundancy versions is four for a reference signal received power (RSRP) value less than −110 decibels per milliwatt (dBm), is three for an RSRP value between −100 dBm and −110 dBm, is two for an RSRP value between −90 dBm and −100 dBm, or is one for an RSRP value greater than −90 dBm; and
transmit the determined number of redundancy versions in the corresponding number of TTIs.

24. The non-transitory computer-readable medium of claim 23, wherein the number of redundancy versions is selected from a plurality of options, wherein the plurality of options includes at least two of: one redundancy version, two redundancy versions, three redundancy versions, or four redundancy versions.

25. The non-transitory computer-readable medium of claim 23, wherein the determined number of redundancy versions is less than four.

26. The non-transitory computer-readable medium of claim 23, wherein the number of redundancy versions is determined based at least in part on one or more of:
at least one signal condition,
acknowledgement or negative acknowledgement (ACK/NACK) feedback received by the UE, or
a combination thereof.

27. An apparatus for wireless communication, comprising:
means for receiving an indication to enable transmission time interval (TTI) bundling;
means for determining a number of redundancy versions to be transmitted in a corresponding number of TTIs for the TTI bundling, wherein the number of redundancy versions is four for a reference signal received power (RSRP) value less than −110 decibels per milliwatt (dBm), is three for an RSRP value between −100 dBm and −110 dBm, is two for an RSRP value between −90 dBm and −100 dBm, or is one for an RSRP value greater than −90 dBm; and
means for transmitting the determined number of redundancy versions in the corresponding number of TTIs.

28. The apparatus of claim 27, wherein the number of redundancy versions is selected from a plurality of options, wherein the plurality of options includes at least two of: one redundancy version, two redundancy versions, three redundancy versions, or four redundancy versions.

29. The apparatus of claim 27, wherein the determined number of redundancy versions is less than four.

30. The apparatus of claim 27, wherein the number of redundancy versions is determined based at least in part on one or more of:
at least one signal condition,
acknowledgement or negative acknowledgement (ACK/NACK) feedback received by the apparatus, or
a combination thereof.

31. The method of claim 1, wherein the number of redundancy versions include repeat request redundancy versions.

32. The UE of claim 12, wherein the number of redundancy versions include hybrid automatic repeat request (HARD) redundancy versions of uplink data.
